(19) United States
(12) Patent Application Publication
(10) Pub. No.: US 2020/0065879 A1
(43) Pub. Date: Feb. 27, 2020

(54) METHODS AND SYSTEMS FOR HOME DEVICE RECOMMENDATION

(71) Applicant: MIDEA GROUP CO., LTD., Foshan City (CN)

(72) Inventors: Ziqiang Hu, Foshan (CN); Xin Chen, San Jose, CA (US)

(21) Appl. No.: 16/109,538

(22) Filed: Aug. 22, 2018

(51) Int. Cl. G06Q 30/06; G06N 99/00

(52) U.S. Cl. CPC G06Q 30/0631; G06N 99/005

(57) ABSTRACT

A system recommends home devices to users. The recommended home devices are identified based at least on the environment where the home devices are to be placed. The system analyzes images representing the environment where a home device is to be placed. Characteristics of the environment are analyzed and used to identify home devices that are compatible with the environment. The system may employ one or more machine learning models to analyze the images. The recommended home devices can be further identified based on users' specification for home devices and/or users' profiles. The system provides previews of the recommended home devices to users such that the users can review placement of the home devices in the environment.

### BACKGROUND

### 1. Technical Field

This disclosure relates generally to computer vision, and more specifically, to discovering and recommending home appliances that are suitable in environments represented in images or videos.

### 2. Description of Related Art

For many households, home and kitchen appliances are major purchases. Shopping for the right piece often requires researches on available home appliances and likely many visits to physical stores. Shoppers must make many decisions such as the features, dimensions, appearances, quality, costs, and locations among many others. The entire shopping experience can be time-consuming, overwhelming, and dreadful. Buyer's remorse is often unavoidable.

### SUMMARY

A method and system for home device recommendation to users. The recommended home devices are identified based at least on the environment where the home devices are to be placed. In some embodiments, the system analyzes images or videos representing the environment where a home device is to be placed. Objects in the environment are recognized and identified. Characteristics of the objects such as a dimension, a color, a shape, a texture, a finish, and the like are determined. In addition, characteristics of the environment such as a color, a theme, a dominant color, a dominant theme, a layout of objects, and the like are determined. The system may employ one or more machine learning models to analyze and understand the images or videos. Based on the results, the system identifies candidate home devices that are compatible in the environment. For example, to evaluate whether a home device is compatible in an environment, the system generates a compatibility score by comparing device data of the home device to the analysis of the environment. The compatibility score reflects a degree of computability of the home device in the environment. The recommended home devices can be further identified based on users' specification for home devices and/or users' profiles.

The system provides the recommended home devices to users. For example, the system generates previews of home devices and provide the previews of the home devices for presentation to the users. The users can review placement of the home devices in the environment. In some embodiments, the preview is an image of a home device being placed in the environment. In some embodiments, a representation of a home device is overlaid onto the real-world environment. The previews of the home devices can be adjusted according to users' configuration of the home devices. Users can provide feedback on the recommended home devices while reviewing the recommendation. The system updates the recommended home devices based on the users' feedback.

Other aspects include components, devices, systems, improvements, methods, processes, applications, computer readable mediums, and other technologies related to any of the above.

### BRIEF DESCRIPTION OF THE DRAWINGS

Embodiments of the disclosure have other advantages and features which will be more readily apparent from the following detailed description and the appended claims, when taken in conjunction with the accompanying drawings, in which:

FIG. 1 is a block diagram of an example environment including a home device recommendation system, in accordance with an embodiment.

FIG. 2A is a block diagram of an example home device recommendation system, in accordance with an embodiment.

FIG. 2B is a flow chart illustrating an example process of recommending home devices in an environment, in accordance with an embodiment.

FIG. 3 is a high-level block diagram illustrating an example computer for implementing the entities shown in FIG. 1.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF EMBODIMENTS

The figures and the following description relate to embodiments by way of illustration only. It should be noted that from the following discussion, alternative embodiments of the structures and methods disclosed herein will be readily recognized as viable alternatives that may be employed without departing from the principles of what is claimed.

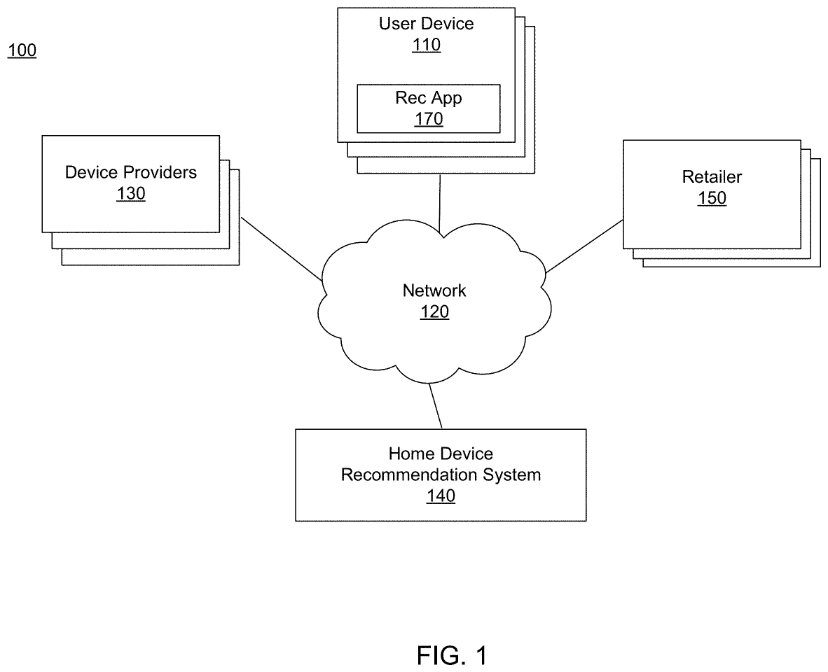

FIG. 1 is a block diagram of an environment 100 including a home device recommendation system 140, in accordance with some embodiments. The environment 100 can be a residential environment or a retail environment. The residential environment is designed for people to live in, whereas the retail environment is designed for people to shop. For example, the residential environment is a dwelling, such as a house, a condo, an apartment, or a dormitory. The retail environment can be a physical or an online store. The home device recommendation system 140 can also be used in other environments such as work, clinic, and education.

The home device recommendation system 140 recommends home devices to users. The recommendation is based at least on an analysis of the environment in which a home device is to be placed. The recommendation can be further based on users' preferences in home devices. The home device recommendation system 140 queries available home devices to find candidate home devices that may satisfy users' requirements and preferences.

Home devices include devices that can be used in a household. Kitchen appliances (e.g., a rice cooker, an oven, a coffee machine, a refrigerator), bathroom appliances, audio devices (e.g., a music player), video devices (e.g., a television, a home theater), HVAC devices (e.g., air conditioner, heater, air venting), and lighting are some example home devices. Other example home devices include powered window and door treatments (e.g., door locks, power blinds and shades), powered furniture or furnishings (e.g., standing desk, recliner chair), environmental controls (e.g., air filter, air freshener), and household robotic devices (e.g., vacuum robot, robot butler).

In addition to the home device recommendation system 140, the environment 100 also includes user devices 110, device providers 130, and retailers 150. The components in FIG. 1 are shown as separate blocks but they may be combined depending on the implementation. The network 120 preferably also provides access to external devices, such as cloud-based services.

The home device recommendation system 140 recommends home devices to users. The recommended home devices are identified based at least on the environment where the home devices are to be placed. In some embodiments, the home device recommendation system 140 analyzes images representing the environment where a home device is to be placed. Images are used as examples to illustrate the operation of the home device recommendation system 140. The home device recommendation system 140 can also analyze videos or other types of media content. Objects in the environment are recognized and identified. Characteristics of the objects such as a dimension, a color, a shape, a texture, a finish, and the like are determined. In addition, characteristics of the environment such as a color, a theme, a dominant color, a dominant theme, a layout of objects, and the like are determined. The home device recommendation system 140 may employ one or more machine learning models to analyze the images. Based on the analysis, the home device recommendation system 140 identifies candidate home devices that are compatible in the environment. For example, to evaluate whether a home device is compatible in an environment, the home device recommendation system 140 generates a compatibility score by comparing device data of the home device to the analysis of the environment. The compatibility score reflects a degree of compatibility of the home device in the environment. The candidate home devices can be further identified based on users' specification for home devices and/or users' profiles. Home devices are selected from the candidate home devices for recommendation to users.

The home device recommendation system 140 provides the recommended home devices to users. For example, the home device recommendation system 140 generates previews of home devices and provides the previews of the home devices for presentation to the users. The users can review placement of the home devices in the environment. In some embodiments, the preview is an image of a home device being placed in the environment. In some embodiments, a representation of a home device is overlaid onto the real-world environment. The previews of the home devices can be adjusted according to users' configuration of the home devices. Users can provide feedback on the recommended home devices while reviewing the recommendation. The home device recommendation system 140 updates the recommended home devices based on the users' feedback. The

The user devices 110 allow users to receive home device recommendation services from the home device recommendation system 140. The home device recommendation system 140 is also referred to herein as the recommendation system 140. The users may interact with the recommendation system 140 by visiting a website hosted by the recommendation system 140. Alternatively, the users may download and install a dedicated application (e.g., a recommendation app 170) to interact with the recommendation system 140. A user may sign up to receive home device recommendation services. The recommendation app 170 is a dedicated app installed on a user device 110. In some embodiments, the recommendation app 170 renders images of the candidate home devices over real-world objects. The recommendation app 170 may employ various augmented reality (AR) technologies to render images of the candidate home devices over real-world objects. For example, the recommendation app 170 causes the user device 110 to project a representation of a recommended home device over the space where the user plans to place the home device. As such, users can experience the home device being placed in the real-world before purchasing the home device.

The recommendation app 170 is configured to generate user interfaces. The user interfaces are configured to allow users to interface with the recommendation app 170 or with the home device recommendation system 140. For example, a user can provide images of an environment to the recommendation app 170 or to the home device recommendation system 140 for analysis. The user can provide an image of a home device to the recommendation app 170 or to the home device recommendation system 140. The user can select which home device is to be replaced or select a space where a home device is to be placed. The user can review a preview of a home device being placed in an environment.

The user devices 110 include computing devices such as mobile devices (e.g., smartphones or tablets with operating systems such as Android or Apple IOS), laptop computers, wearable devices, desktop computers, smart automobiles or other vehicles, or any other type of network-enabled device that downloads, installs, and/or executes applications. A user device 110 may query an API hosted by the recommendation system 140. A user device 110 typically includes hardware and software to connect to the network 120 (e.g., via Wi-Fi and/or Long Term Evolution (LTE) or other wireless telecommunication standards), to receive input from the users, to capture images, and to render images. In addition to enabling a user to receive home device recommendation services from the recommendation system 140, user devices 110 may also provide the recommendation system 140 with data about the status and use of user devices, such as their network identifiers and geographic locations.

The device providers 130 provide home devices to the public. The device providers 130 include manufacturers that manufacture home devices such as fridges, ovens, washers, dryers, and the like. The device provider 130 may provide information about home devices that it manufactures. A list of available home devices, a list of distributors where a home device can be acquired, a list of retailers where a home device can be acquired, a datasheet of a home device, and a suggested retail price of a home device, are some example information. In some embodiments, the information is made available to other entities in the environment 100 via the network 120.

The retailers 150 resell the home devices provided by the device providers 130 to the public. The retailers 150 may provide information about the home devices that it resells. A list of home devices is one example information. Information associated with a home device may include a price, a promotion event, a quantity, a status (e.g., in stock, out of stock), shipping information, an available date if it is out of stock, or a data sheet. A particular home device can be identified by a unique home device ID such as its model. Information associated with the home device can be stored as metadata. The retailers 150 may make the information available to other entities in the environment 100 via the network 120. The retailers 150 can have e-commerce and/or physical stores where users can purchase home devices.

The network 120 provides connectivity between the different components of the environment 100 and enables the components to exchange data with each other. The term “network” is intended to be interpreted broadly. It can include formal networks with standard defined protocols, such as Ethernet and InfiniBand. The network 120 can also combine different types of connectivity. It may include a combination of local area and/or wide area networks, using both wired and/or wireless links. Data exchanged between the components may be represented using any suitable format. In some embodiments, all or some of the data and communications may be encrypted.

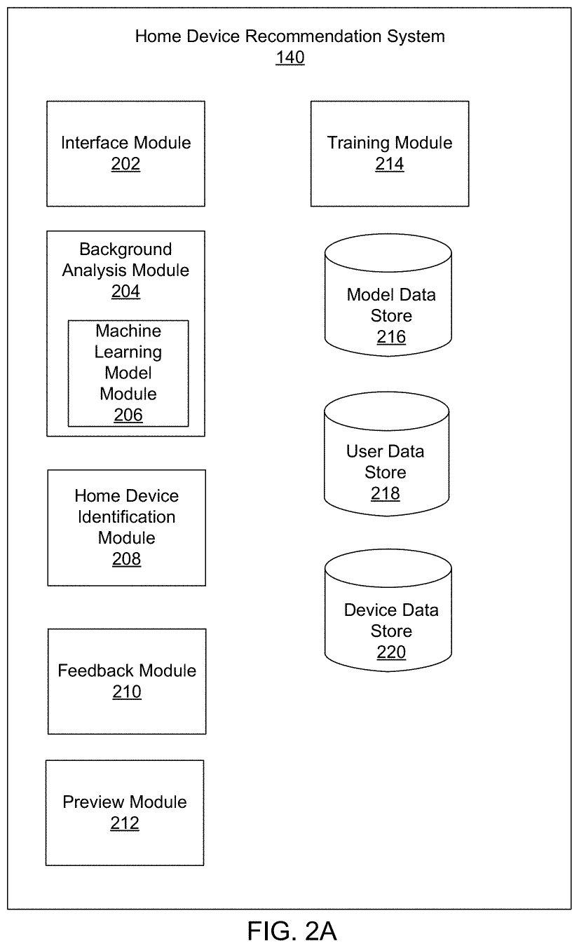

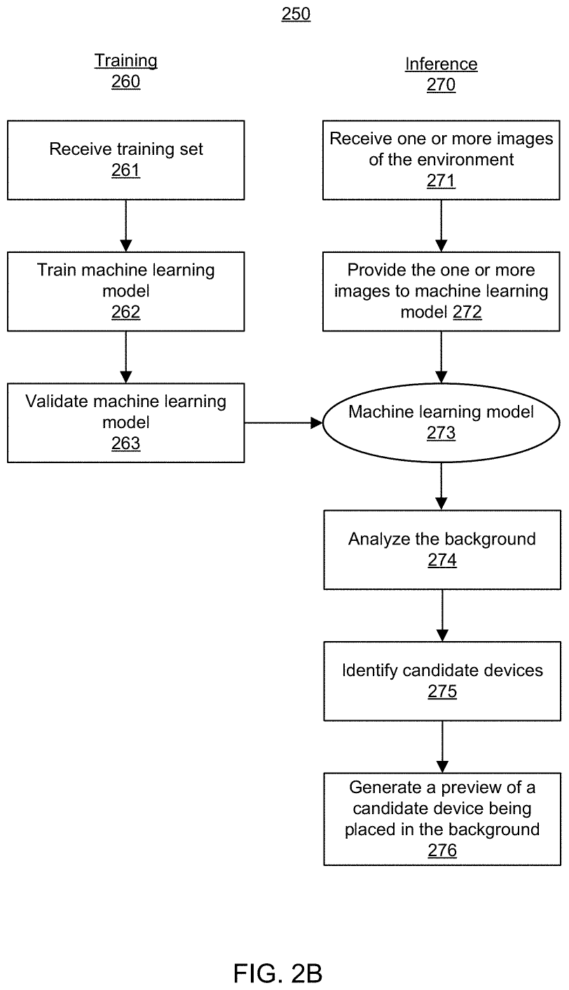

FIG. 2A is a block diagram of a home device recommendation system 140, in accordance with the invention. The home device recommendation system 140 includes an interface module 202, a background analysis module 204, a home device identification module 208, a feedback module 210, a preview module 212, a training module 214, a model data store 216, a user data store 218, and a device data store 220. The background analysis module 204 includes a machine learning model module 206. In other embodiments, the home device recommendation system 140 may include different components. FIG. 2B is a flow chart illustrating a process 250 of recommending home devices in an environment 100, in accordance with some embodiments. In one embodiment, the process is conducted by the home device recommendation system 140. The process 250 includes two main phases: a training process 260 to develop a machine learning model 273 and inference (operation) 270 of the machine learning model 273. In one embodiment, the inference (operation) 270 is conducted by the recommendation app 170.

The interface module 202 facilitates communications of the home device recommendation system 140 with other components of the environment 100. For example, via the interface module 202, the home device recommendation system 140 receives images. The images can represent an environment or a home device. Via the interface module 202, the home device recommendation system 140 receives requests for home device recommendation. For example, a user can input a request for home device recommendation. The request for home device recommendation can include a selection of a home device to be replaced, specification of a replacement home device, or other information. The specification of the replacement home device can include information describing the user's preferences for the replacement home device such as a dimension, a price range, a brand, a make, a model, a design, a feature (e.g., whether the home device has an energy star, a power level, a specific operation mode, etc.), and the like. A user can select the home device to be replaced by clicking on an area on the image illustrating the device. Additionally, a preview of a home device is dispatched via the interface module 210. The preview of the home device can include a representation of the home device alone or a representation of the home device being placed in a space.

The interface module 202 further receives user feedback on candidate home devices from users. A user feedback may be positive indicating that the user liking a candidate home device, or negative indicating that the user disliking a candidate home device. In some embodiments, the interface module 202 receives images including users' faces or other body parts. The user feedback is determined from the users' facial expressions, gestures, body movements, and the like. For example, a smile or a nod indicates a positive user feedback whereas a frown or a head-shaking indicates a negative user feedback. The liking or disliking can be of various degrees such as strong, moderate, and weak, which can be determined from the user feedback.

The background analysis module 204 analyzes the background in which a home device is to be placed. For example, the background analysis module 204 analyzes one or more images representing the background to determine characteristics of one or more objects in the background. The characteristics may include characteristics of individual objects such as a dimension (2D or 3D) of the object, a color of the object, a shape of the object, a texture of the object, a finish of the object, a pattern of the object, a material of the object, a brand of the object, a model of the object, a price range of the object, and the like. The characteristics may also include an overall visual appearance of the background such as relative positions of the objects present in the background, relative positions of the colors (textures, finishes, patterns, or materials) of the objects present in the background, a layout of the objects present in the background, a layout of the colors (textures, finishes, patterns, or materials) of the objects present in the background, the colors (textures, finish, patterns, or materials) present in the background, a dominant color (texture, finish, pattern, or material) in the background, brands of home devices present in the background, a dominant brand of the home devices present in the background, price ranges of home devices present in the background, a dominant price range of the home devices present in the background, a theme (e.g., modern, contemporary, minimalist, industrial, mid-century modern, Scandinavian, etc.), and the like.

The background analysis module 204 may apply various approaches to analyze one or more images thereby to analyze the background represented in the one or more images. In some embodiments, an image is a video frame. The background analysis module 204 can analyze a sequence of video frames. Specifically, the background analysis module 204 analyzes image features of the one or more images thereby to determine characteristics of the background represented in the one or more images. The background analysis module 204 may segment pixels of an image into different regions. Various semantic segmentation and/or instance segmentation approaches can be used to segment the pixels. For each region, the background analysis module 204 may further identify and classify one or more objects represented in the region. For example, the background analysis module 204 segments an image into one region including pixels representing a wall and another region including pixels representing a fridge. The background analysis module 204 classifies the object represented in the first region as a wall and the object represented in the second region as a fridge. Based on the image features, regions, and/or objects, the background analysis module 204 may further determine the characteristics of the objects as well as the overall visual appearance of the background.

The background analysis module 204 may include a machine learning model module 206 to analyze images. The machine learning model module 206 applies one or more machine learning models, artificial intelligence models, classifiers, decision trees, neural networks, or deep learning models to analyze images. Unless specified otherwise, a machine learning model, artificial intelligence model, classifier, decision tree, neural network, or deep learning model that is employed by the machine learning model module 206 is hereinafter referred to as a model. A model can be obtained from the model data store 216. A model may include model parameters that classify objects and determine characteristics of objects such as determining mappings from pixel values to image features or mappings from pixel values to object characteristics. For example, model parameters of a logistic classifier include the coefficients of the logistic function that correspond to different pixel values.

As another example, a model is a decision tree model, which is a directed acyclic graph where nodes correspond to conditional tests for an image feature and leaves correspond to classification outcomes (e.g., presence or absence of one or more object characteristics). The parameters of the example decision tree include (1) an adjacency matrix describing the connections between nodes and leaves of the decision tree; (2) node parameters indicating a compared image feature, a comparison threshold, and a type of comparison (e.g., greater than, equal to, less than) for a node; and/or (3) leaf parameters indicating which object characteristics or visual appearance feature corresponds to which leaves of the decision tree.

As a third example, a model includes model parameters indicating how to combine results from two separate models (e.g., a decision tree and a logistic classifier). When a model receives image features, the machine learning model module 206 retrieves model parameters and maps the image features to object characteristics according to model parameters. Model parameters of the model are determined by the training module 214 which is described below.

The home device identification module 208 identifies candidate home devices that are compatible with the background and that meet a user's specification. To identify candidate home devices that are compatible with the background, the home device identification module 208 evaluates the overall effect of the home devices stored in the device data store 220 if they were placed in the environment. The evaluation can be based on one or more of factors such as the dimension, the color, the texture, the pattern, the finish, and the like. For a particular device, the home device identification module 208 evaluates device data of the home device along with image data of the one or more images representing the background. The device data of a home device may include one or more images representing the home device. The home device identification module 208 may generate a compatibility score indicating a degree of compatibility of the home device in the background. The compatibility score is generated, for example, based on the device data of the device as well as image data of the one or more images representing the background. A home device with a higher compatibility score is more compatible in the background than another home device with a lower compatibility score.

The home device identification module 208 queries home device specification provided by the user in the device data store 220 for results that match the user's specification. For a particular home device, the home device identification module 208 may generate a matching score indicating a degree of a home device matching the user's specification. The matching score is generated by comparing a home device's associated device data to corresponding criteria specified in the user's specification. For a criterion in the user's specification, the home device identification module 208 generates a sub-score reflecting whether a home device's associated device data satisfies the criterion. The sub-scores for all criterion specified in the user's specification are combined to generate the matching score. A criterion may be associated with a particular weight reflecting the criterion's importance in the user's preference. The matching score is the sum of weighted sub-scores. A criterion can be required or optional. If a criterion is required, home devices of which the device data that does not satisfy the criterion are excluded from the results that match the user's specification. For a home device, the home device identification module 208 may combine the compatibility score and the matching score to generate a final score.

The home device identification module 208 may select the candidate home devices of which the final scores above a threshold for recommendation to the user. The home device identification module 208 may rank the selected candidate home devices based on the final score. The home devices can be presented to the user based on the ranked order.

Concurrently when presenting the candidate home devices to the user, the home device identification module 208 may update the candidate home devices based on user feedback on the home devices that have been provided to them. For example, if a user likes a particular home device that is presented to him, the home device identification module 208 updates the selection of candidate home devices to include more home devices that are similar to this particular home device. The home device identification module 208 may also rank the candidate home devices that are similar to this particular home device higher than other candidate home devices that are not similar to this particular home device. Conversely, if a user dislikes a particular home device, the home device identification module 208 updates the selection of candidate home devices to exclude home devices that are similar to this particular home device. The home device identification module 208 may also rank the candidate home devices that are similar to this particular home device lower than other candidate devices that are distinct from this particular home device. By doing this, the home device identification module 208 presents the user with home devices that the user is more likely to like.

The home device identification module 208 may further identify candidate home devices based on users' profiles. The users' profiles include users' general preferences for home devices such as brands, colors, themes, price ranges, retailers, and the like. The user profiles may be obtained from the user data store 218.

The feedback module 210 determines the user feedback and provides the user feedback to the home device identification module 208. For example, the user feedback module 210 analyzes images or videos received at the interface module 202 to determine whether a user feedback is positive or negative and a degree of liking or disliking. The user feedback module 210 user feedback is determined from the users' facial expressions, gestures, body movements, and the like. For example, a smile or a nod indicates a positive user feedback whereas a frown or a head-shaking indicates a negative user feedback. The liking or disliking can be of various degrees such as strong, moderate, and weak, which can be determined from the user feedback. The feedback module 210 may employ one or more machine learning models (not shown) that determine the user feedback. The received user feedback can be included in training data to develop the one or more machine learning models.

The preview module 212 generates previews of candidate home devices to be placed in the background represented in the images provided by the user. In some embodiments, the preview module 212 generates a representation of a candidate home device alone or being placed in the environment. The preview module 212 may adjust the representation to reflect adjusting the dimension of the candidate home device according to a dimension of the space where the candidate home device is to be placed. In some embodiments, the preview module 212 integrates images of the candidate home devices with the images representing the environment. The preview presents to a user an overall appearance of a candidate home device being placed in the environment. As such, the user can review the overall visual effect of an environment if a candidate home device were placed in the background. The preview module 212 provides the generated previews to the interface module 202 for provision to the user. In some embodiments, the previews are presented via a user device 110. In some embodiments, the previews are projected to the real-world to provide an augmented reality experience to the user.

The training module 214 determines the model parameters according to training data. The training data includes images already associated with recognized objects. For example, the training data includes images representing different backgrounds and different objects. The images may or may not be labeled with features. The training module 214 may use any number of artificial intelligence or machine learning techniques to train and modify model parameters, including gradient tree boosting, logistic regression, neural network training, and deep learning. The training module 214 stores the determined model parameters for use in the model data store 216. The training module 214 may train different model types to recognize objects, to detect boundaries between the objects and the background, to determine dimensions of the objects, to determine overall visual appearance of the background, and the like. Based on the desired function, the training module 214 may select one of the model types for use.

The model data store 216 stores models that can be employed by the machine learning model module 206. A model is defined by an architecture with a certain number of layers and nodes, with weighted connections (parameters) between the nodes. The model may be trained to perform one or more different functions such as recognizing objects, identifying a home device, detecting boundaries between objects and background, determining overall visual appearance of the background, and the like.

The user data store 220 stores user data associated with users. The user data includes user preferences in home devices such as a dimension, a price range, a brand, a make, a model, a design, a feature (e.g., whether the home device has an energy star, a power level, a specific operation mode, etc.), preferences in designs such as colors, textures, finishes, patterns, materials, or themes (e.g., modern, contemporary, minimalist, industrial, mid-century modern, Scandinavian, etc.); and the like. Other user data may include users' online activity history such as a browsing history of home devices, a history of liked or disliked home devices, a history of liked or disliked designs, and the like.

The device data store 218 stores home device data associated with home devices. The home device data includes a model, a make, an availability, a retailer, a distributor, a datasheet, a price, a brand, a design, a feature, an image, and other information about the home device.

The training module 214 receives 261 a training set for training. The training samples in the set include reference images of home devices as well as reference images of environments with or without home devices. The training module 214 can receive these reference images from administrators who develop the home device recommendation system 140. The training module 214 may further receive reference images via the interface module 210 from other entities in the environment 100 illustrated in FIG. 1. For example, the training module 214 receives images of home devices from the device providers or from the retailers 150. As another example, the training module 214 receives images of environments from the user devices 110. In some embodiments, the machine learning model 273 can be trained using images from other sources such as social networking sites. For supervised learning, the training set typically includes tags for the images. The tags include descriptions of the environment resident in the image, such as a home device model, a style, a theme, a color, or a feature thereof. For examples, tags for fridge training images can include “fridge,” “top freezer,” “bottom freezer,” “side-by-side,” “built-in” “stainless steel,” “French door,” “compact,” or “built-in ice maker.”

In typical training 262, a training sample is presented, as an input, to the machine learning model 273, which then produces an output. The output can be a recognition of a home device, an identification of a home device, a detection of a boundary of a home device, a detection of a dimension of a home device, a determination of a dimension of a space in a background, a color recognition, a finish recognition, a layout recognition, a theme determination, and the like. The difference between the machine learning model's output and the known good output is used by the training module 214 to adjust the values of the parameters in the machine learning model 273. This is repeated for many different training samples to improve the performance of the machine learning model 273.

The training module 214 typically also validates 263 the trained machine learning model 273 based on additional validation samples. For example, the training module 214 applies the machine learning model 273 to a set of validation samples to quantify the accuracy of the machine learning model 273. The validation sample set includes images of home devices and know attributes of the home devices, as well as images of backgrounds and known attributes of the backgrounds. The output of the machine learning model 273 can be compared to the known ground truth. Common metrics applied in accuracy measurement include Precision=TP/(TP+FP) and Recall=TP/(TP+FN), where TP is the number of true positives, FP is the number of false positives and FN is the number of false negatives. Precision is how many outcomes the machine learning model 273 correctly predicted had the target attribute (TP) out of the total that it predicted had the target attribute (TP+FP). Recall is how many outcomes the machine learning model 273 correctly predicted had the target attribute (TP) out of the total number of validation samples that actually did have the target attribute (TP+FN). The F score (F-score=2*Precision*Recall/(Precision+Recall)) unifies Precision and Recall into a single measure. Common metrics applied in accuracy measurement also include Top-1 accuracy and Top-5 accuracy. Under Top-1 accuracy, a trained model is accurate when the top-1 prediction (i.e., the prediction with the highest probability) predicted by the trained model is correct. Under Top-5 accuracy, a trained model is accurate when one of the top-5 predictions (e.g., the five predictions with highest probabilities) is correct.

The training module 214 may use other types of metrics to quantify the accuracy of the trained model. In one embodiment, the training module 214 trains the machine learning model until the occurrence of a stopping condition, such as the accuracy measurement indication that the model is sufficiently accurate, or a number of training rounds having taken place.

In another embodiment, the machine learning model 273 can be continuously trained 262, concurrently when providing the home device recommendation services. For example, the training module 214 uses the image set received from the user devices 110 to further train the machine learning model 273.

Inference 270 of the machine learning model 273 may occur at the same location as the training 260 or at a different location. In some embodiments, the machine learning model 273 can be trained and execute in a cloud. For example, the home device recommendation system 140 is connected to the cloud. The home device recommendation system 140 can share computing resources with or from the cloud or store computing resources in the cloud. In one implementation, the training 260 is more computationally intensive, so it is cloud-based or occurs on a server with significant computing power. Once trained, the machine learning model 273 can be distributed to the user devices 110, the retailers 150, and/or the device providers 130, which can execute the machine learning model using fewer computing resources than is required for training. The machine learning model 273 can be compressed before being distributed to other entities in the environment 100.

During inference 270, the home device recommendation system 140 receives 271 one or more images of an environment from the user devices 110. The home device recommendation system 140 provides 272 the received images to the machine learning model 273. The machine learning model 273 analyzes 274 the background. Specifically, the machine learning model 273 identifies the visual characteristics of the background such as a color, a texture, a theme, a layout of objects, a dominant color, a dominant texture, and the like. The machine learning model 273 calculates a probability of each visual characteristic of the background. This calculation can be based on a machine learning model 273 that does not use reference images of a visual characteristic for the inference step 270.

Alternately, the machine learning model 273 can use reference images as part of the inference step 270. For example, part of the calculation may be a correlation of input images against reference images for the known background. The machine learning model 273 calculates a similarity of the captured images to reference images of environments of known features (e.g., color, design theme, finish, etc.) For example, the machine learning model 273 calculates distance between the captured images and reference images of different backgrounds. The reference images of different backgrounds can include representations of the backgrounds from different perspectives. The different images may be weighted, for example based on their ability to distinguish between backgrounds of different characteristics (e.g., color, design theme, finish, etc.) Based on the weights, the machine learning model 273 further calculates a weighed combination based on the distances. The weighted combination can equal to a sum of the products of each distance and its corresponding weight. The weighted combination indicates the similarity of the image set to the reference images.

Based on the calculated probabilities or similarities, the machine learning model 273 identifies which visual characteristic is most likely. For example, the machine learning model 273 identifies a theme with the highest probability or similarly as the theme. In a situation where there are multiple visual characteristics with similar probability or similarity, the machine learning model 273 may further distinguish those visual characteristics with similar probability or similarity. For example, the machine learning model 273 requests additional images. These additional images can be used to refine the output of the machine learning model 273.

In some embodiments, the machine learning model 273 detects a boundary between a home device and the background. A user can select the home device by clicking on or tapping the representation of the home device on a user interface that is provided by the interface module 202 or by the recommendation app 170. After the user inputs the selection, the machine learning model 273 detects the boundary.

In some embodiments, the machine learning model 273 determines a dimension of a space where a home device is to be placed. A user can select the space by clicking on or tapping a particular location on an image to select a space where a home device is to be placed. The selection can be provided via a user interface that is provided by the interface module 202 or by the recommendation app 170. After the user inputs the selection, the machine learning model 273 determines the dimension. The dimension can be determined by using the machine learning model 273 analyzing multiple images that represent the environment from different perspectives. The dimension can also be determined by determining a dimension of the object being placed in the space. The dimension of the object can be determined, for example, from the model data store 216 by looking up the object. The object can be identified by its model or other unique identifying information that can be obtained from the image. Based on the dimension of the object and the detected boundary, the dimension of the space can be estimated.

The home device recommendation system 140 identifies 275 candidate devices based at least on the analysis of the background. The identification may be further based on user specification for candidate home devices and user profiles. Details of identifying candidate devices are provided previously with respect to FIG. 2A and are omitted here.

The home device recommendation system 140 generates 276 a preview of the candidate devices. Details of identifying candidate devices are provided previously with respect to FIG. 2A and are omitted here.

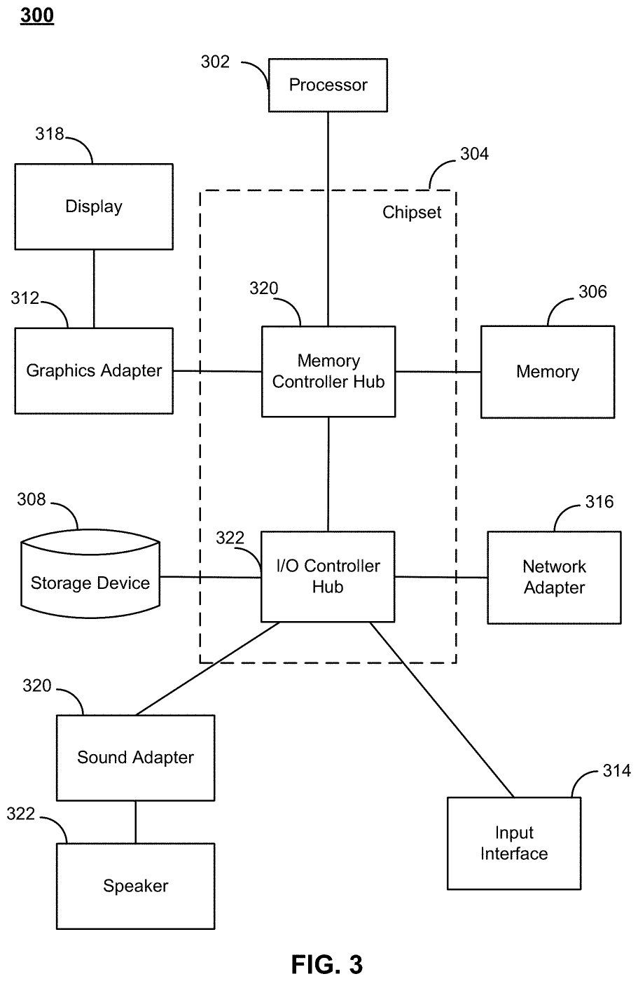

FIG. 3 is a high-level block diagram illustrating an example computer 300 for implementing the entities shown in FIG. 1. The computer 300 includes at least one processor 302 coupled to a chipset 304. The chipset 304 includes a memory controller hub 320 and an input/output (I/O) controller hub 322. A memory 306 and a graphics adapter 312 are coupled to the memory controller hub 320, and a display 318 is coupled to the graphics adapter 312. A storage device 308, an input interface 314, and network adapter 316 are coupled to the I/O controller hub 322. Other embodiments of the computer 300 have different architectures.

The storage device 308 is a non-transitory computer-readable storage medium such as a hard drive, compact disk read-only memory (CD-ROM), DVD, or a solid-state memory device. The memory 306 holds instructions and data used by the processor 302. The input interface 314 is a touch-screen interface, a mouse, track ball, or other type of pointing device, a keyboard, or some combination thereof, and is used to input data into the computer 300. In some embodiments, the computer 300 may be configured to receive input (e.g., commands) from the input interface 314 via gestures from the user. The graphics adapter 312 displays images and other information on the display 318. The network adapter 316 couples the computer 300 to one or more computer networks.

The computer 300 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 308, loaded into the memory 306, and executed by the processor 302.

The types of computers 300 used by the entities of FIG. 1 can vary depending upon the embodiment and the processing power required by the entity. For example, the home device recommendation system 140 can run in a single computer 300 or multiple computers 300 communicating with each other through a network such as in a server farm. The computers 300 can lack some of the components described above, such as graphics adapters 312, and displays 318.

Although the detailed description contains many specifics, these should not be construed as limiting the scope of the invention but merely as illustrating different examples and aspects of the invention. It should be appreciated that the scope of the invention includes other embodiments not discussed in detail above. For example, identification of an individual may be based on information other than images of different views of the individual's head and face. For example, the individual can be identified based on height, weight, or other types of distinctive features. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

Alternate embodiments are implemented in computer hardware, firmware, software, and/or combinations thereof. Implementations can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

What is claimed is:

1. A method for recommending home devices, comprising:
receiving one or more images representing a scene of an environment including an area from a user device;
receiving a request for candidate home devices to be placed in the area;
analyzing the environment by providing the one or more images to a machine learning model;
identifying a set of candidate home devices based at least on the analysis;
for each candidate home device, generating a preview of the candidate home device; and
providing at least one preview to the user device for presentation to a user.

2. The method of claim 1, wherein the one or more images include a representation of an object occupying the area, wherein analyzing the environment comprises detecting the object and identifying a boundary of the object, further comprising:
segmenting the representation of the object from the one or more images.

3. The method of claim 1, wherein analyzing the environment comprises determining a dimension of the area, and wherein identifying a set of candidate home devices comprises querying the dimension of the area in a plurality of home devices, each candidate home device fitting the area.

4. The method of claim 3, wherein determining a dimension of the area comprises determining a 3D dimension of the space from a plurality of images, the plurality of images capturing the space from multiple perspectives.

5. The method of claim 3, wherein determining a dimension of the area comprises identifying an object placed in the area, determining a dimension of the object, and estimating a 3D dimension of the space based on the dimension of the object.

6. The method of claim 5, wherein identifying an object placed in the area comprises processing the representation of the object to identify a model of the object, and wherein determining a dimension of the object comprises looking up the dimension of the object based on the model.

7. The method of claim 1, wherein analyzing the environment comprises determining visual characteristics of the environment, and wherein identifying a set of candidate home devices comprises comparing visual characteristics of a plurality of home devices to the visual characteristics of the environment.

8. The method of claim 7, wherein comparing visual characteristics of the home devices to the visual characteristics of the environment comprises:
for each home device, calculating a compatibility score based on the visual characteristics of the home device and the visual characteristics of the environment,
wherein the compatibility score indicates a degree of compatibility of the home device in the environment, and
wherein each candidate home device is associated with the computability score greater than a threshold.

9. The method of claim 1, wherein the preview of the user device is overlaid onto the space in the environment.

10. The method of claim 1, wherein the request for candidate home devices is associated with a specification specifying the user's preference for the candidate home devices, wherein the set of candidate home devices is further identified based on the specification, and wherein identifying the set of candidate home devices comprises:
for each home device, generating a matching score by comparing a specification associated with the home device to the specification specifying the user's preference, wherein the matching score indicates a degree of the home device satisfying the specification, and
wherein each candidate home device is associated with the matching score greater than a threshold.

11. The method of claim 1, further comprising retrieving a user's profile including information about the user's preference for home devices, wherein the set of candidate home devices is further identified based on the user's preference.

12. The method of claim 1, further comprising:
receiving a user input indicating the user liking one of the candidate home devices; and
updating the set of candidate home devices based on the user input, comprising:
prioritizing candidate home devices similar to the one of the candidate home devices in the set of candidate home devices or including more candidate home devices similar to the one of the candidate home devices in the set of candidate home devices.

13. The method of claim 1, further comprising:
receiving a user input indicating the user disliking one of the candidate home devices; and
updating the set of candidate home devices based on the user input, comprising:
prioritizing candidate home devices dissimilar to the one of the candidate home devices in the set of candidate home devices or excluding candidate home devices similar to the one of the candidate home devices from the set of candidate home devices.

14. The method of claim 1, wherein the preview of the candidate home device is a representation of the candidate home device being placed in the area in the environment.

15. A system comprising:
a processor for executing computer program instructions; and
a non-transitory computer-readable storage medium storing computer program instructions executable by the processor, the computer program instructions configured to cause the processor to perform:
receiving one or more images representing a scene of an environment including an area from a user device;
receiving a request for candidate home devices to be placed in the area;
analyzing the environment by providing the one or more images to a machine learning model;
identifying a set of candidate home devices based at least on the analysis;
for each candidate home device, generating a preview of the candidate home device; and
providing at least one preview to the user device for presentation to a user.

16. The system of claim 15, wherein the one or more images include a representation of an object occupying the area, and wherein the computer program instructions comprise instructions for segmenting the representation of the object from the one or more images.

17. The system of claim 15, wherein the computer program instructions for analyzing the environment comprises instructions for determining visual characteristics of the environment, and wherein the computer program instructions for identifying a set of candidate home devices comprises instructions for comparing visual characteristics of a plurality of home devices to the visual characteristics of the environment.

18. The system of claim 17, wherein the computer program instructions for comparing visual characteristics of the home devices to the visual characteristics of the environment comprises instructions for:
for each home device, calculating a compatibility score based on the visual characteristics of the home device and the visual characteristics of the environment,
wherein the compatibility score indicates a degree of compatibility of the home device in the environment, and
wherein each candidate home device is associated with the computability score greater than a threshold.

19. The system of claim 15, wherein the request for candidate home devices is associated with a specification specifying the user's preference for the candidate home devices, wherein the set of candidate home devices is further identified based on the specification, and wherein the computer program instructions for identifying the set of candidate home devices comprise instructions for:
for each home device, generating a matching score by comparing a specification associated with the home device to the specification specifying the user's preference, wherein the matching score indicates a degree of the home device satisfying the specification, and
wherein each candidate home device is associated with the matching score greater than a threshold.

20. A non-transitory computer-readable storage medium storing computer program instructions executable by a processor, the computer program instructions configured to cause the processor to perform:
receiving one or more images representing a scene of an environment including an area from a user device;
receiving a request for candidate home devices to be placed in the area;
analyzing the environment by providing the one or more images to a machine learning model;
identifying a set of candidate home devices based at least on the analysis;
for each candidate home device, generating a preview of the candidate home device; and
providing at least one preview to the user device for presentation to a user.
